(19) United States
(12) Patent Application Publication
(10) Pub. No.: US 2008/0269421 A1
(43) Pub. Date: Oct. 30, 2008

(54) Polyethylene Composition Having a Broad Molecular Weight Distribution

(75) Inventors: Jorunn Nilsen, Porsgrunn (NO); Arno Johansen, Stathelle (NO); Jari Aarila, Porvoo (FI)

Correspondence Address: OBLON, SPIVAK, MCCLELLAND MAIER & NEUSTADT, P.C., 1940 DUKE STREET, ALEXANDRIA, VA, 22314, US

(73) Assignee: BOREALIS TECHNOLOGY OY, Porvoo (FI)

(21) Appl. No.: 12/067,659

(22) PCT Filed: Sep. 22, 2006
(86) PCT No.: PCT/FI2006/000309

§ 371 Date: Jul. 2, 2008

(30) Foreign Application Priority Data
Sep. 22, 2005 (EP) 05020627.5

(51) Int. Cl. C08L 23/06; C08F 2/00

(52) U.S. Cl. 525/240; 526/352; 526/65; 526/64

(57) ABSTRACT

An ethylene polymer composition having a density of 935 to 950 kg/m³, a dynamic Viscosity η_{0.05} measured at a frequency of 0.05 rad/s of 2000 to 7000 Pa-s and a shear thinning index SHI_{1/100} of 4 to 15 is provided. Due to said combination of properties the composition of the invention can be processed with high production rates to end products with good properties, e.g. in terms of appearance and transparency, which are very desirable in many application areas such as moulding including film applications.

### BACKGROUND OF THE INVENTION

The present invention deals with polyethylene compositions for making cast films. In the cast film process the molten polymer is extruded through a flat die to one or more chill rolls where it is cooled, and then rolled up. This type of process is disclosed, among others in Raff and Doak, Crystalline Olefin Polymers, Part II, pages 450-453 (John Wiley & Sons, 1964) and in Vieweg, Schley and Schwarz, Kunststoff Handbuch, Band IV, Polyolefine, pages 402-408 (Carl Hanser Verlag, 1969).

### FIELD OF THE INVENTION

The present invention deals with ethylene polymer compositions for the preparation of cast films. More specifically, the present invention deals with ethylene polymer compositions that can be processed into films in a casting process with a good processability, minimum neck-in and reduced risk of draw resonance.

### DESCRIPTION OF RELATED ART

The document WO 98/30628 discloses bimodal ethylene polymer compositions suitable for extrusion coating. The examples showed polymers having MFR₂ of 9-13 g/10 min, density of 930-942 kg/m³.

The document WO 00/71615 discloses bimodal ethylene polymers suitable for injection moulding. The polymer comprises a low molecular weight component and a high molecular weight component. The examples disclose polymers with MFR₂ of 1.7-4.8 g/10 min, density of at least 953 kg/m³ and the ratio of the amount of the low molecular weight component to the amount of the high molecular weight component of 40/60 or 60/40.

### SUMMARY OF THE INVENTION

The aim of the invention is to provide an ethylene polymer composition which has a very feasible balance between processability and mechanical properties

Accordingly, the present invention provides an ethylene polymer composition having a density of 935 to 950 kg/m³, a dynamic viscosity η_{0.05} measured at a frequency of 0.05 rad/s of 2000 to 7000 Pa·s and a shear thinning index SHI_{1/100} of 4 to 15. Due to said combination of properties the composition of the invention can be processed with high production rates to end products with good properties, e.g. in terms of appearance and transparency, which are very desirable in many application areas such as moulding including film applications.

The ethylene polymer composition has preferably a melt index MFR₂ of 0.5 to 5.0 g/10 min.

The ethylene polymer composition has typically a weight average molecular weight, M_{w}, of from 70000 to 150000 g/mol.

The molecular weight distribution, defined as M_{w}/Mₙ, of the present ethylene polymer composition may vary depending on the end application, and the present ethylene composition with M_{w}/Mₙ from 7 to 17 has particularly advantageous properties suitable for film applications, e.g. cast film applications.

The ethylene polymer composition is preferably a multimodal composition with respect to the molecular weight distribution and/or comonomer distribution. According to one preferable embodiment the ethylene polymer composition is at least a bimodal with respect to the molecular weight distribution, wherein the composition comprises a low molecular weight polymer component (A), which is an ethylene homopolymer or a copolymer of ethylene and one or more alpha-olefins having from 4 to 10 carbon atoms, said low molecular weight component (A) having a melt index MFR₂ of from 50 to 2000 g/10 min, preferably from 50 to 350 g/10 min, and a high molecular weight polymer component (B), which is a copolymer of ethylene and one or more alpha-olefins having from 4 to 10 carbons, said high molecular weight polymer component (B) having a melt index which is lower than that of component (A), whereby component (A) is in the amount of 41 to 59% by weight and component (B) in amount of 59 to 41% by weight based on the total amount of component (A) and (B). In one preferable embodiment the ethylene polymer composition is said bimodal composition. Alternatively, the composition may comprise at least three different ethylene polymer components, whereby the amount of the third or further components may vary considerably. It is herein understood that the bimodal ethylene composition may e.g. comprise a prepolymer fraction as the third component.

In case of a multimodal ethylene polymer composition said low molecular weight polymer component (A) has preferably a density of from 950 to 978 kg/m³, and said high molecular weight polymer component (B) has a density which is lower than that of component (A).

Said low molecular weight polymer component (A) has typically a weight average molecular weight of from 15000 to 50000 g/mol. Preferably, said high molecular weight polymer component (B) has a weight average molecular weight of from 170000 to 80000 g/mol.

In case of a multimodal ethylene polymer composition the mixture of the ethylene polymer components may be a mechanical blend or a in situ blend or a mixture of a mechanical blend and an in-situ blend, wherein part of the components have been blended in situ and then mixed mechanically with the other component(s) of the composition. The in situ blend means that the components are mixed together during the polymerization process thereof the composition as described below. The meaning of the terms “in situ blend” and “mechanical blend” are well known in the filed.

The composition of the invention can further be mixed with other components. Such mixtures, i.e. blends, comprise an ethylene polymer composition as defined above together with other components are thus also provided. The other components may be other polymer components and/or additives, such as additives conventionally used in polymers. The choice and amounts depend naturally on the end applications thereof.

### DESCRIPTION OF THE FIGURES

FIG. 1 shows a viscosity plot of the polymer according to the invention. The dynamic viscosity is plotted as a function of the frequency in rad/s. The polymer of Example 1 is denoted as 1394 in the diagram and can be seen to have a higher shear thinning than the commercially available prior art polymers, denoted as 1067 and 1390. These correspond to Comparative Examples 1 and 2, respectively. This more pronounced shear thinning behaviour is advantageous in film extrusion, as it makes it possible to obtain high throughput rates in high shear rate processing conditions.

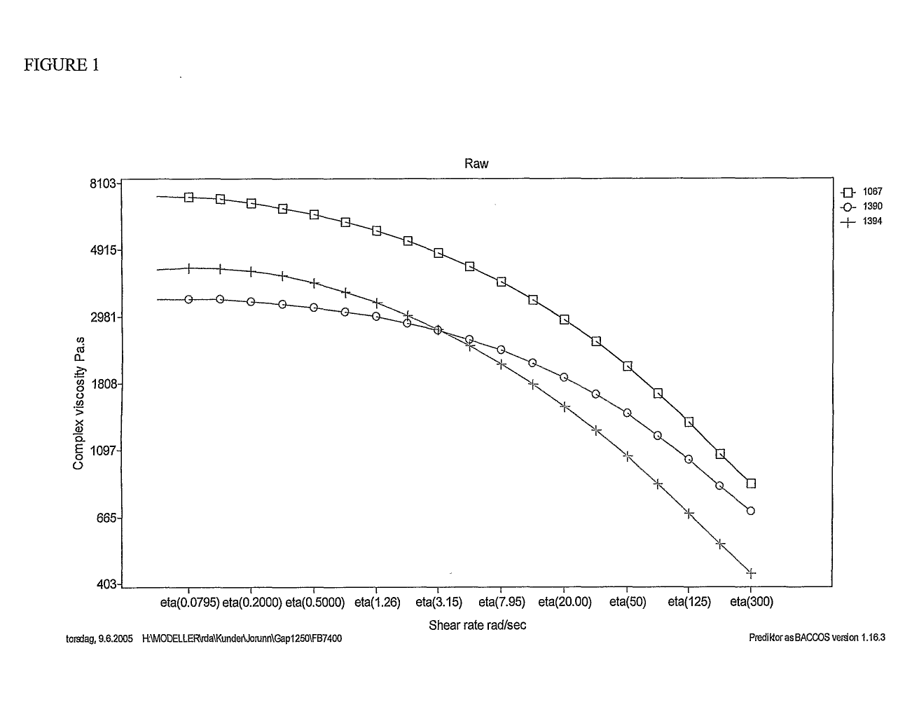

### DETAILED DESCRIPTION OF THE INVENTION

### Polymer Composition

According to the invention, the polymer composition may be unimodal or multimodal and is preferably multimodal comprising from 41 to 59% by weight of the total weight of (A) and (B) the low molecular weight polymer component (A) and from 59 to 41% by weight of the total weight of (A) and (B) the high molecular weight polymer component (B).

### Low Molecular Weight Polymer Component (A)

The low molecular weight polymer component (A) is a homopolymer of ethylene or a copolymer of ethylene and one or more alpha-olefin comonomers having from 4 to 10 carbon atoms. It has a melt index MFR₂ of from 50 to 2000 g/10 min, preferably from 50 to 500 g/10 min, more preferably from 50 to 350 g/10 min. Further, it has a density of from 950 to 978 kg/m³, preferably from 955 to 978 kg/m³. Preferably the low molecular weight polymer component is an ethylene homopolymer. It has preferably a weight average molecular weight of 15000 to 50000 g/mol, preferably from 20000 to 50000 g/mol.

### High Molecular Weight Ethylene Polymer Component (B)

The high molecular weight polymer component (B) is a copolymer of ethylene and one or more alpha-olefins having from 4 to 10 carbon atoms. It has a melt index which is lower than that of component (A). Preferably, it has a melt index MFR₂ of from 0.03 to 1.0 g/10 min. It has a density lower than that of component (A). Preferably, it has a density of 900 to 930 kg/m³. It preferably has a weight average molecular weight of 170000 to 800000 g/mol. Preferably, the high molecular weight component has a comonomer content of 3.3 to 5.5% by mole, and especially preferably from 3.5 to 5.0% by mole. In addition, the comonomer content of the high molecular weight component (B) is higher than the comonomer content of the low molecular weight component (A), preferably by at least 2.0% by mole.

### Polymer Composition

The polymer composition comprises from 41 to 59%, preferably from 41 to 52%, by weight of the combined weights of components (A) and (B) of the low molecular weight component (A) and from 59 to 41%, preferably from 59 to 48%, by weight of the combined weights of components (A) and (B) of the high molecular weight component (B). The composition has a melt index MFR₂ of from 0.5 to 5 g/10 min, preferably from 1 to 5 g/10 min, and a density of from 935 to 950 kg/m³. Further, the composition preferably has a weight average molecular weight M_{w} of from 70000 to 170000 g/mol, more preferably from 80000 to 150000 g/mol. It preferably has a molecular weight distribution defined as the ratio of the weight average molecular weight to the number average molecular weight, M_{w}/Mₙ of from 7 to 17, preferably from 8 to 15. Further still, the polymer composition has a dynamic viscosity η_{0.05} measured at a frequency of 0.05 rad/s of from 2000 to 7000 Pa·s, preferably from 3000 to 6500 Pa·s, especially preferably from 3000 to 5500 Pa·s. It has a shear thinning index SHI_{1/100}, defined as the ratio of two dynamic viscosities measured at the values of shear stress of 1 kPa and 100 kPa, of from 4 to 15, preferably from 5 to 11. In addition, the polymer composition preferably has a comonomer content of 1.5 to 3.5% by mole, more preferably from 1.5 to 3.0% by mole.

According to a further embodiment, the invention provides a blend comprising a multimodal ethylene polymer composition, said composition comprising:

(i) from 41 to 59% by weight of a low molecular weight polymer component (A), which is an ethylene homopolymer or a copolymer of ethylene and one or more alpha-olefins having from 4 to 10 carbon atoms, said low molecular weight component (A) having:
a melt index MFR₂ of from 50 to 2000 g/10 min, preferably from 50 to 350 g/10 min,
a density of from 950 to 978 kg/m³, and
a weight average molecular weight of 15000 to 50000 g/mol;
   (ii) from 59 to 41% by weight of a high molecular weight polymer component (B), which is a copolymer of ethylene and one or more alpha-olefins having from 4 to 10 carbons, said high molecular weight polymer component (B) having:
a melt index which is lower than that of component (A),
a density which is lower than that of component (A),
a comonomer content of 3.3 to 5.5% by mole, and
a weight average molecular weight of from 170000 to 800000 g/mol,
   the composition having
a melt index MFR₂ of 0.5 to 5 g/10 min,
a density of 935 to 950 kg/m³,
a weight average molecular weight of from 70000 to 150000 g/mol
a molecular weight distribution of from 7 to 17
a dynamic viscosity η_{0.05} measured at a frequency 0.05 rad/s of 2000 to 7000 Pas
a shear thinning index SHI_{1/100} of 4 to 15.

The polymer composition may contain additives and adjuvants known in the art. Thus, it may contain antioxidants and stabilisers, such as Irganox 1010 and Irgaphos 168 that are commercial products of Ciba Specialty Chemicals. It may contain antistatic agents such as ethoxylated amines, ethoxylated amides and glycerol monostearates, antiblock agents such as talc or silica, slip agents such as oleamide and erucamide, acid neutralisers such as calcium stearate and zinc stearate, processing aids such as fluoroelastomers, and nucleating agents such as sodium benzoate. Suitable amounts of such additives are well known in the art. The person skilled in the art is able to select the suitable additives and their amounts to reach the desired properties of the composition and the films made thereof.

### Use of the Composition

The composition can be used to produce different types of articles. Especially useful the composition is for making films, and in particular cast films. The composition can be extruded to films with good processability and high throughput with reduced risk of draw resonance and low neck-in. The resulting films are free of fish-eyes, melt fracture and other visual defects. Clear films can be produced from the composition.

### Production of the Composition

The polymer composition may be produced by any polymerisation method that is known in the art, such as in slurry, solution or gas phase polymerisation. The polymerisation can be a single or multistage polymerisation.

A multimodal, e.g. at least bimodal, polymer composition as defined above, which comprises at least two polymer components (A) and (B) with differing MWD and/or with differing comonomer contents, may be produced by blending each or part of the components in-situ during the polymerisation process thereof (so called in-situ process) or, alternatively, by blending mechanically two or more separately produced components in a manner known in the art.

Preferably the ethylene polymer composition is multimodal, whereby the invention further provides a process for producing a polymer composition comprising at least two different ethylene homo- or copolymer components (A) and (B) as defined above, wherein each component is produced by polymerising ethylene monomers, optionally together with one or more alpha-olefin comonomers, in the presence of a polymerisation catalyst in a single or a multistage polymerisation process. The components (A) and (B) are preferably produced in a multistage process using one or more polymerisation reactors, which may be the same or different, e.g. at least slurry-slurry, gas phase-gas phase or any combination of slurry and gas phase polymerisations. Each stage may be conducted in parallel or sequentially using same or different polymerisation method. In case of a sequential stages each of the components (A) and (B), may be produced in any order by carrying out the polymerisation in each step, except the first step, in the presence of the polymer component formed in the preceding step(s). Preferably, also the catalyst used in the preceding steps is present in the subsequent polymerisation step(s). Alternatively, further catalyst, which can be the same or different than that used in the preceding step, can be added in the subsequent step(s).

### Catalyst

The catalyst is not critical; however, preferably a Ziegler-Natta polymerisation catalyst is used. Such catalysts comprise a transition metal component and an activator.

The transition metal component comprises a metal of Group 4 or 5 of the Periodic System (IUPAC) as an active metal. In addition, it may contain other metals or elements, like elements of Groups 2, 13 and 17. Preferably, the transition metal component is a solid. More preferably, it has been supported on a support material, such as inorganic oxide carrier or magnesium halide. Examples of such catalysts are given, among others in WO 95/35323, WO 01/55230, EP 810235 and WO 99/51646. The catalysts disclosed in WO 95/35323 are especially useful as they are well suited in production of both a polyethylene having a high molecular weight and a polyethylene having a low molecular weight. Thus, especially preferably the transition metal component comprises a titanium halide, a magnesium alkoxy alkyl compound and an aluminium alkyl dihalide supported on an inorganic oxide carrier.

The activator is a compound which is capable of activating the transition metal component. Useful activators are, among others, aluminium alkyls and aluminium alkoxy compounds. Especially preferred activators are aluminium alkyls, in particular aluminium trialkyls, such as trimethyl aluminium, triethyl aluminium and tri-isobutyl aluminium. The activator is typically used in excess to the transition metal component. For instance, when an aluminium alkyl is used as an activator, the molar ratio of the aluminium in the activator to the transition metal in the transition metal component is from 1 to 500 mol/mol, preferably from 2 to 100 mol/mol and in particular from 5 to 50 mol/mol.

It is also possible to use in combination with the above-mentioned two components different co-activators, modifiers and the like. Thus, two or more alkyl aluminium compounds may be used, or the catalyst components may be combined with different types of ethers, esters, silicon ethers and the like to modify the activity and/or the selectivity of the catalyst, as is known in the art.

Suitable combinations of transition metal component and activator are disclosed among others, in the examples of WO 95/35323.

It is preferred that the catalyst would produce in one-stage ethylene homopolymerisation at 80° C. a polymer having a molecular weight distribution M_{w}/Mₙ of from about 3 to 7, when the resulting polymer has MFR₂ of about 1 g/10 min. This corresponds to FRR_{21/2} of from about 25 to about 40. This would allow the preparation of the composition having the desired combination of viscosity and shear thinning index.

### Pre-Polmerisation

In some cases it is preferred that the polymerisation stage is preceded by a prepolymerisation stage. In prepolymerisation a small amount of an olefin, preferably from 0.1 to 500 grams of olefin per one gram catalyst is polymerised. Usually the prepolymerisation takes place at a lower temperature and/or lower monomer concentration than the actual polymerisation. Typically, the prepolymerisation is conducted from 0 to 90° C., preferably from 10 to 80° C. Usually, but not necessarily, the monomer used in the prepolymerisation is the same that is used in the subsequent polymerisation stage(s). It is also possible to feed more than one monomer into the prepolymerisation stage. Descriptions of prepolymerisation can be found in e.g. WO 96/18662, WO 03/037941, GB 1532332, EP 517183, EP 560312 and EP 99774. Most suitably the polymerisation is conducted in two or more cascaded polymerisation stages where each polymer component is produced in a separate polymerisation stage and a polymer component produced in an earlier stage is present in each of the subsequent polymerisation stage(s).

### Polymerisation Stage to Produce the Low Molecular Weight Component (A)

In the polymerisation stage producing the low molecular weight component (A) ethylene is homopolymerised or copolymerised with one or more alpha-olefin comonomers having from 4 to 10 carbon atoms. The polymerisation may take place in slurry, solution or gas phase.

The temperature in the polymerisation reactor needs to be sufficiently high to reach an acceptable activity of the catalyst. On the other hand, the temperature should not exceed the softening temperature of the polymer. The temperature may be selected from the range of 50 to 110° C., preferably 75 to 105° C. and more preferably 75 to 100° C.

The pressure in the reactor can be selected to fulfil the desired objectives: to reach a desired density of the reaction medium, to reach a suitable monomer concentration or to maintain the reactor contents in liquid phase. Therefore, the pressure depends on in which phase the reaction is conducted. Suitable pressure range in slurry polymerisation is 10 to 100 bar, preferably 30 to 80 bar. In gas phase polymerisation the pressure is from 5 to 50 bar, preferably from 10 to 30 bar.

If the low molecular weight component (A) is produced in slurry, ethylene and an inert diluent are introduced into the reactor together with the polymerisation catalyst. Hydrogen is introduced into the reactor to control the melt index of the polymer. Further, comonomer may be used to control the density of the polymer. The exact amounts of hydrogen and eventual comonomer are set by the type of catalyst used and the targeted MFR and density. Suitably, the ratio of hydrogen to ethylene in the fluid phase is from 50 to 800 mol/kmol and the ratio of the comonomer to ethylene is from 0 to 300 mol/kmol, preferably from 0 to 200 mol/kmol.

If the polymerisation is conducted as a slurry polymerisation, any suitable reactor type known in the art may be used. A continuous stirred tank reactor and a loop reactor are suitable examples of useful reactor types. Especially, a loop reactor is preferred because of its flexibility. Especially advantageous it is to conduct the polymerisation above the critical temperature and pressure of the fluid, in so called supercritical conditions. Such operation is disclosed in WO 92/12181.

The low molecular weight component (A) can also be produced in a gas phase reactor. In that case a gas mixture comprising monomer, an inert gas, hydrogen and optionally comonomer is introduced into the reactor. The catalyst is often introduced into a bed of polymer, where the polymerisation takes place. Again, hydrogen and optionally comonomer are introduced into the reactor to control the MFR and density of the polymer. Typically, the ratio of hydrogen to ethylene in the gas phase is from 500 to 15000 mol/kmol and the ratio of the comonomer to ethylene is from 0 to 300 mol/kmol, preferably from 0 to 150 mol/kmol.

### Polymerisation Stage to Produce the High Molecular Weight Component (B)

In the polymerisation stage producing the high molecular weight component (B) ethylene is copolymerised with one or more alpha-olefin comonomers having from 4 to 10 carbon atoms. The polymerisation may take place in slurry, solution or gas phase.

The temperature in the polymerisation reactor needs to be sufficiently high to reach an acceptable activity of the catalyst. On the other hand, the temperature should not exceed the softening temperature of the polymer. The temperature may be selected from the range of 50 to 110° C., preferably 75 to 105° C. and more preferably 75 to 100° C.

The pressure in the reactor can be selected to fulfil the desired objectives: to reach a desired density of the reaction medium, to reach a suitable monomer concentration or to maintain the reactor contents in liquid phase. Therefore, the pressure depends on in which phase the reaction is conducted. Suitable pressure range in slurry polymerisation is 10 to 100 bar, preferably 30 to 80 bar. In gas phase polymerisation the pressure is from 5 to 50 bar, preferably from 10 to 30 bar.

If the high molecular weight component (B) is produced in slurry, ethylene and an inert diluent are introduced into the reactor together with the polymerisation catalyst. Hydrogen is introduced into the reactor to control the melt index of the polymer. Further, comonomer is used to control the density of the polymer. The exact amounts of hydrogen and comonomer are set by the type of catalyst used and the targeted MFR and density. Suitably, the ratio of hydrogen to ethylene in the fluid phase is from 5 to 150 mol/kmol and the ratio of the comonomer to ethylene is from 50 to 500 mol/kmol, preferably from 50 to 300 mol/kmol.

The high molecular weight component (B) can also be produced in a gas phase reactor. In that case a gas mixture comprising monomer, an inert gas, hydrogen and optionally comonomer is introduced into the reactor. The catalyst is often introduced into a bed of polymer, where the polymerisation takes place. Again, hydrogen and optionally comonomer are introduced into the reactor to control the MFR and density of the polymer. Typically, the ratio of hydrogen to ethylene in the gas phase is from 10 to 500 mol/kmol and the ratio of the comonomer to ethylene is from 100 to 600 mol/kmol, preferably from 150 to 500 mol/kmol.

Thus the process for producing the above polymer composition, comprising at least (A) a low molecular weight ethylene (co)polymer component and (B) a high molecular weight copolymer component as defined above, includes preferably the steps of:

(a) polymerising in a slurry reactor zone, preferably a loop reactor, ethylene monomer, optionally together with one of more comonomers, preferably alpha-olefin comonomers, in the presence of a polymerisation catalyst to produce the first polymer component (preferably (A)), and, optionally, transferring the reaction product of step (a) to a subsequent gas phase reactor zone,
(b) polymerising in a gas phase reactor zone ethylene monomer, optionally together with one or more alpha-olefin comonomers, in the presence of the reaction product of step (a) to produce a second polymer component (preferably (B)) for obtaining the polymer composition of the invention,
and recovering the obtained composition.

It is known in the art to polymerise in at least two polymerisation stages to produce bimodal polyolefins, such as bimodal polyethylene, as disclosed in WO 92/12182 and EP 22376.

### Extrusion

After the polymer is collected from the reactor and the hydrocarbon residues are removed therefrom, the polymer is compounded and extruded to pellets. In this process step, any extruder known in the art may be used. It is preferred, however, to use a twin screw extruder. It may be of a co-rotating type, such as those produced by Werner & Pfleiderer having a designation ZSK, e.g. ZSK 90 having a 90 mm screw diameter. Alternatively, it may be of a counter-rotating type, such as those produced by Japan Steel Works, having a designation JSW CIM-P, e.g. CIM90P, having a 90 mm screw diameter, or LCM continuous mixer by Kobe Steel, such as LCM500H, or Farrel continuous mixer (FCM) by Farrel. It is especially preferred to use a counter-rotating twin screw extruder.

The extruder may contain one or more gear pumps and throttle valves. This equipment can be used to improve the homogeneity of the polymer composition or to increase the capacity of the extruder. Such a solution is disclosed, among others, by T. Fukui and R. Minato: “LCM Continuous Mixer/Gear Pump System for Polyolefin Resins”, Society of Plastics Engineers Polyolefins VII International Conference, Feb. 24-27, 1991, Wyndham Greenspoint Hotel, Houston, Tex.

Before the extrusion the polymer may be mixed with the desired additives.

### Description of Analytical Methods

### Molecular Weight

Average molecular weights and molecular weight distribution were determined by size exclusion chromatography (SEC) using Waters Alliance GPCV2000 instrument with on-line viscometer. Oven temperature was 140° C. Trichlorobenzene was used as a solvent.

In the cases where the average molecular weight could not be measured from the component, for instance when the component had been produced in the second polymerization stage in a two-stage polymerization process, the weight average molecular weight of the missing component can be calculated from the overall weight average molecular weight and that of the first component as follows:

$${M}_{w , 2} = \frac{{M}_{w , o} - {w}_{1} \cdot {M}_{w , 1}}{{w}_{2}}$$

and the number average molecular weight as follows:

$${M}_{n , 2} = \frac{{w}_{2}}{\frac{1}{{M}_{n , o}} - \frac{{w}_{1}}{{M}_{n , 1}}}$$

where M_{w} and Mₙ denote the weight average molecular weight and number average molecular weigh, respectively,
subscripts o, 1 and 2 denote the overall composition, component 1 and component 2, respectively, and
w denotes the weight fraction of the component in the total weight of components 1 and 2.

### Melt Flow Rate

Melt flow rate of the polymer was determined according to ISO 1133 at 190° C. under a load of 2.16 kg (MFR₂).

In the cases where the melt flow rate could not be measured from the component, for instance when the component had been produced in the second polymerization stage in a two-stage polymerization process, the overall melt flow rate o can be calculated from the melt flow rates of the individual components as follows:

MFRₒ=(Σwᵢ·MFRᵢ^{a})^{1/a}

where MFR denotes the melt flow rate,
the subscripts o and i denote the overall composition and component i, respectively,
w denotes the weight fraction, and
a is a constant having a value of −0.314.

### Density

Density of the polymer was determined according to ISO 1183-1987.

In the cases where the density could not be measured from the component, for instance when the component had been produced in the second polymerization stage in a two-stage polymerization process, the density of the missing component can be calculated from the overall density and that of the first component as follows:

$${ρ}_{2} = \frac{{ρ}_{o} - {w}_{1} \cdot {ρ}_{1}}{{w}_{2}}$$

where w and the subscripts 1, 2 and o are as defined above, and
ρ is the density.

### Comonomer Content

Comonomer content (wt %) was determined in a known manner with ¹³C-NMR on Bruker 400 MHz spectrometer at 130° C. from samples dissolved in 1,2,4-trichlorobenzene (TCB)/benzene (with 90 parts per weight TCB and 10 parts per weight benzene).

In the cases where the comonomer content could not be measured from the component, for instance when the component had been produced in the second polymerization stage in a two-stage polymerization process, the comonomer content of the missing component can be calculated from the overall comonomer content and that of the first component as follows:

$${c}_{2} = \frac{{c}_{o} - {w}_{1} \cdot {c}_{1}}{{w}_{2}}$$

where the subscripts 1, 2 and o are as defined above, and
c is the comonomer content on weight basis.

The comonomer content in the weight basis can be calculated from the comonomer content in molar basis as follows:

$${c}_{w} = \frac{1}{1 + ( \frac{1}{{c}_{n}} - 1 ) \cdot \frac{M {W}_{e}}{M {W}_{c}}}$$

where the subscripts e and c denote ethylene and comonomer, respectively
c_{w} denotes the weight fraction of comonomer units in the polymer,
cₙ denotes the mole fraction of comonomer units in the polymer, and
MW denotes the molecular weight.

### Dynamic Viscosity and Shear Thinning Index

Dynamic rheological measurements were carried out with a rheometer, namely Rheometrics RDA-II, on compression moulded samples under nitrogen atmosphere at 190° C. using 25 mm diameter plates and plate and plate geometry with a 1.2 mm gap. The oscillatory shear experiments were done within the linear viscosity range of strain at frequencies from 0.05 to 300 rad/s (ISO 6721-1). Five measurement points per decade are made.

The values of storage modulus (G′), loss modulus (G″) complex modulus (G*) and complex viscosity (η*) were obtained as a function of frequency (ω). η₁₀₀ is used as abbreviation for the complex viscosity at the frequency of 100 rad/s.

Shear thinning index (SHI), which correlates with MWD and is independent of M_{w}, was calculated according to Heino (“Rheological characterization of polyethylene fractions” Heino, E. L., Lehtinen, A., Tanner J., Seppälä, J., Neste Oy, Porvoo, Finland, Theor. Appl. Rheol., Proc. Int. Congr. Rheol, 11 (1992), 1, 360-362, and “The influence of molecular structure on some rheological properties of polyethylene”, Heino, E. L., Borealis Polymers Oy, Porvoo, Finland, Annual Transactions of the Nordic Rheology Society, 1995.)

SHI value is obtained by calculating the complex viscosities η*(1 kPa) and η*(100 kPa) at a constant value of complex modulus of 1 kPa and 100 kPa, respectively. The shear thinning index SHI_{1/100} is defined as the ratio of the two viscosities η*(1 kPa) and η*(100 kPa), i.e. η(1)/η(100).

The definitions and measurement conditions are also described in detail on page 8 line 29 to page 11, line 25 of WO 00/22040.

It is usually not practical to measure the complex viscosity at the value of frequency of 0.05 rad/s directly. The value can be extrapolated by conducting the measurements down to the frequency of 0.126 rad/s, drawing the plot of complex viscosity vs. frequency, drawing a best-fitting line through the five points corresponding to the lowest values of frequency and reading the viscosity value from this line.

### EXAMPLES

### Example 1

Into a loop reactor having a volume of 500 dm³ were continuously introduced propane, ethylene and hydrogen. In addition, a polymerisation catalyst prepared otherwise according to Example 3 of WO 95/35323 except that the average particle size of the silica carrier was 25 μm was introduced into the reactor together with triethyl aluminium so that the molar ratio of aluminium in the activator to titanium in the solid component was 15. The loop reactor was operated at 95° C. temperature and 60 bar pressure. Ethylene content in the fluid phase in the slurry reactor was 5.5% by mole and the ratio of hydrogen to ethylene was 360 mol/kmol. The production rate of polymer was 30 kg/h. The polymer produced in the loop reactor had an MFR₂ of 250 g/10 min and a density of 973 kg/m³.

The slurry was withdrawn from the loop reactor by using the settling legs and directed to a flash where the pressure was reduced to 3 bar. The polymer containing a minor amount of residual hydrocarbons was directed to a fluidised bed gas phase reactor, where also additional ethylene, 1-butene comonomer and hydrogen were added, together with nitrogen as an inert gas. The gas phase reactor was operated at a temperature of 82° C. and a pressure of 20 bar. The ethylene partial pressure in the fluidising gas in the reactor was 3.5 bar, the hydrogen to ethylene ratio was 83 mol/kmol and the ratio of 1-butene to ethylene was 360 mol/kmol. The production rate of the polymer in the gas phase reactor was 37 kg/h, so that the production split between the loop and gas phase reactors was 45/55. The total production rate was thus 67 kg/h.

The polymer was mixed with 750 ppm of Doverphos 9228 and 750 ppm of calcium stearate and extruded into pellets in a counterrotating twin-screw extruder JSW CIM90P. The polymer pellets had a density of 940 kg/m³ and an MFR₂ of 3.0 g/10 min. They further had M_{w} of 115000, Mₙ of 10000 and MWD thus 12. The dynamic viscosity η_{0.05} was 4250 Pa·s and SHI_{1/100} was 7.0. The 1-butene content of the polymer was 3.8% by weight.

### Comparative Example 1

A commercially available ethylene polymer composition was analysed in terms of the rheology. The dynamic viscosity η_{0.05} was 7370 Pa·s and SHI_{1/100} was 3.4.

### Comparative Example 2

Another commercially available ethylene polymer composition was analysed in terms of the rheology. The dynamic viscosity η_{0.05} was 3380 Pa·s and SH_{1/100} was 2.7.

1. An ethylene polymer composition having a density of 935 to 950 kg/m3, a dynamic viscosity η_{0.05} measured at a value of the frequency of 0.05 rad/s of 2000 to 7000 Pa·s and a shear thinning index SHI1/100 of 4 to 15.

2. The ethylene polymer composition according to claim 1, wherein the composition has a melt index MFR2 of 0.5 to 5.0 g/10 min.

3. The ethylene polymer composition according to claim 1, wherein the composition has a weight average molecular weight, Mw, of from 70000 to 150000 g/mol.

4. The ethylene polymer composition according to claim 1, wherein the composition has a molecular weight distribution, defined as Mw/Mn, of from 7 to 17.

5. The ethylene polymer composition according to claim 1, wherein the composition comprises a low molecular weight polymer component (A), which is an ethylene homopolymer or a copolymer of ethylene and one or more alpha-olefins having from 4 to 10 carbon atoms, said low molecular weight component (A) having a melt index MFR2 of from 50 to 2000 g/10 min, and a high molecular weight polymer component (B), which is a copolymer of ethylene and one or more alpha-olefins having from 4 to 10 carbons, said high molecular weight polymer component (B) having a melt index which is lower than that of component (A), whereby the amount of component (A) is of 41 to 59% by weight and the amount of component (B) of 59 to 41% by weight based on the total amount of component (A) and (B).

6. The ethylene polymer composition according to claim 5, wherein said low molecular weight polymer component (A) has a density of from 950 to 978 kg/m3, and said high molecular weight polymer component (B) has a density which is lower than that of component (A).

7. The ethylene polymer composition according to claim 5, wherein said low molecular weight polymer component (A) has a weight average molecular weight of from 15000 to 50000 g/mol, and said high molecular weight polymer component (B) has a weight average molecular weight of from 170000 to 80000 g/mol.

8. A blend comprising an ethylene polymer composition according to claim 1.

9. A blend according to claim 8, comprising a multimodal ethylene polymer composition, said composition comprising:
(i) from 41 to 59% by weight of a low molecular weight polymer component (A), which is an ethylene homopolymer or a copolymer of ethylene and one or more alpha-olefins having from 4 to 10 carbon atoms, said low molecular weight component (A) having:
a melt index MFR2 of from 50 to 2000 g/10 min,
a density of from 950 to 978 kg/m3,
a weight average molecular weight of 15000 to 50000 g/mol;
(ii) from 59 to 41% by weight of a high molecular weight polymer component (B), which is a copolymer of ethylene and one or more alpha-olefins having from 4 to 10 carbons, said high molecular weight polymer component (B) having:
a melt index which is lower than that of component (A),
a density which is lower than that of component (A)
a comonomer content of 3.3 to 5.5% by mole,
a weight average molecular weight of from 170000 to 800000 g/mol,
the composition having
a melt index MFR2 of 0.5 to 5 g/10 min,
a density of 935 to 950 kg/m3,
a weight average molecular weight of from 70000 to 150000 g/mol
a molecular weight distribution of from 7 to 17
a dynamic viscosity η_{0.05} measured at a frequency of 0.05 rad/s of 2000 to 7000 Pas
a shear thinning index SHI1/100 of 4 to 15.

10. A blend according to claim 9 wherein the blend comprises from 30 to 99% of the multimodal ethylene polymer composition and from 1 to 70% of low density polyethylene.

11. A method for making articles, comprising shaping the composition of claim 1.

12. The method according to claim 11, wherein the article is a film.

13. The method according to claim 12, wherein the article is a cast film.

14. A cast film comprising a layer comprising the ethylene polymer composition according to claim 1.

15. A process for producing a composition having a density of 935 to 950 kg/m3, a dynamic viscosity η_{0.05} measured at a frequency of 0.05 rad/s of 2000 to 7000 Pa·s and a shear thinning index SHI1/100 of 4 to 15 comprising:
providing ethylene, hydrogen, a polymerization catalyst comprising a transition metal component, said transition metal component comprising a metal of Group 4 or 5 of the Periodic System (IUPAC) as an active metal, together with an aluminium trialkyl activator, and optionally an alpha-olefin comonomer having 4 to 10 carbon atoms into a first polymerisation zone where an ethylene polymer component (A) having a melt index MFR2 of from 50 to 2000 g/10 min is formed;
providing ethylene, hydrogen, said polymerisation catalyst and alpha-olefin comonomer having 4 to 10 carbon atoms into a second polymerisation zone where an ethylene polymer component having a melt index which is lower than that of component (A) is formed;
wherein the polymerization is conducted in two cascaded zones so that the polymer formed in an upstream zone is present in the downstream polymerization zone and the combined composition of components (A) and (B) comprises from 41 to 59% of component (A) and 59 to 41% of component (B).

16. The process according to claim 15, wherein said polymer component (A) has a density of from 950 to 978 kg/m3, and said polymer component (B) has a density which is lower than that of component (A).

17. The process according to claim 15, wherein said first polymerization zone is a loop reactor and said second polymerization zone is a gas phase reactor.
